(19) United States
(12) Patent Application Publication
(10) Pub. No.: US 2015/0189012 A1
(43) Pub. Date: Jul. 2, 2015

(54) WIRELESS DISPLAY SYNCHRONIZATION FOR MOBILE DEVICES USING BUFFER LOCKING

(71) Applicant: NVIDIA CORPORATION, Santa Clara, CA (US)

(72) Inventors: Mahesh Sambhaji JADHAV, Sangli (IN); Jeetendra MALKANI, Pune (IN); Amol Babasaheb SHINDE, Pune (IN)

(73) Assignee: NVIDIA CORPORATION, Santa Clara, CA (US)

(21) Appl. No.: 14/146,650

(22) Filed: Jan. 2, 2014

(51) Int. Cl. H04L 29/08; H04L 29/06; H04W 56/00

(52) U.S. Cl. CPC H04L 67/1095; H04W 56/0015; H04L 65/403

(57) ABSTRACT

One embodiment of the present invention includes techniques for synchronizing displays of a plurality of mobile devices over a wireless network. A processing unit renders an image frame related to a software application into an application image buffer associated with a first mobile device and causes a second mobile device to render a second image frame into a second application image buffer of the second mobile device. The processing unit receives an acknowledgement over a wireless network indicating that the second mobile device has completed rendering the second image frame. The processing unit displays contents of the application image buffer on a first display device associated with the first mobile device and transmits a signal to the second mobile device over a wireless network that causes the second mobile device to display contents of the second application image buffer on a second display device associated with the second mobile device.

### BACKGROUND OF THE INVENTION

1. Field of the Invention

Embodiments of the present invention relate generally to computer displays and, more specifically, to wireless display synchronization for mobile devices using buffer locking.

2. Description of the Related Art

Mobile devices, such as smart phones and pad devices are often used in group environments to support presentations or training programs. For example, a presenter or teacher could display visual content, such as a video clip or a graphical user interface (GUI) of a software application, on a mobile device, and audience members would display the same visual content on their own mobile devices. A presenter could present a video clip by directing the audience members to load the video clip into a player application, and start and stop the video clip at various points of interest. Alternatively, a presenter could provide a training program for a particular software application by directing audience members to load and run the application, load an input file, and perform various commands using the GUI associated with the application. Each audience member would view the same content, more or less, on his or her mobile device as displayed on the presenter's mobile device.

One drawback to the above approach is that the various mobile devices operated by the audience members may be displaying an image frame at a different place in the video clip or on a different GUI screen of the software application. Accordingly, the presenter may not be able to effectively present visual content to an audience using mobile devices.

As the foregoing illustrates, what is needed in the art is a more effective way to present information to an audience of multiple persons via their respective mobile devices.

### SUMMARY OF THE INVENTION

One embodiment of the present invention sets forth a method for synchronizing displays of a plurality of mobile devices over a wireless network. The method includes rendering a first image frame related to a software application into a first application image buffer associated with a first mobile device. The method further includes causing a second mobile device to render a second image frame substantially similar to the first image frame into a second application image buffer associated with the second mobile device. The method further includes receiving an acknowledgement over a wireless network indicating that the second mobile device has completed rendering the second image frame into the second application image buffer. The method further includes displaying contents of the first application image buffer on a first display device associated with the first mobile device. The method further includes transmitting a signal to the second mobile device over a wireless network that causes the second mobile device to display contents of the second application image buffer on a second display device associated with the second mobile device.

Other embodiments include, without limitation, a computer-readable medium that includes instructions that enable a processing unit to implement one or more aspects of the disclosed methods. Other embodiments include, without limitation, a computing device that includes a processing unit configured to implement one or more aspects of the disclosed methods as well as a system configured to implement one or more aspects of the disclosed methods.

One advantage of the disclosed approach is that a group of mobile devices stay frame-synchronized during playback of visual content or during execution of a software application. A presenter may ensure that all non-master mobile devices are synchronized to the master mobile device during a presentation or training program.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIG. 3 is a block diagram of a mobile device, according to one embodiment of the present invention;

FIG. 4 illustrates a share group of mobile devices communicating over a wireless network, according to one embodiment of the present invention; and

FIGS. 5A-5C set forth a flow diagram of method steps for synchronizing display buffers of a plurality of mobile devices, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

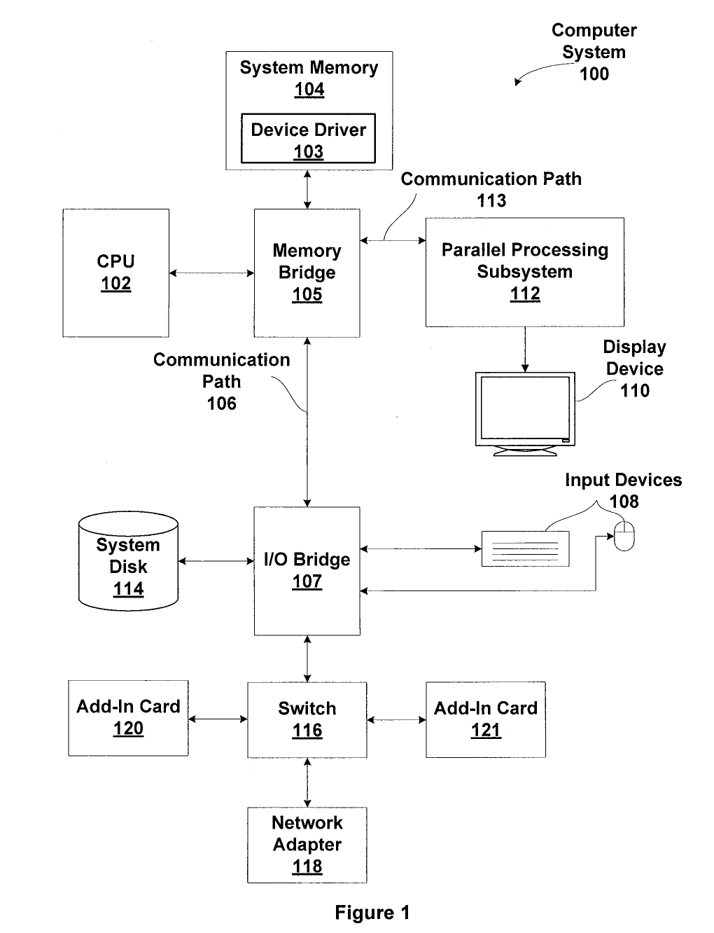

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

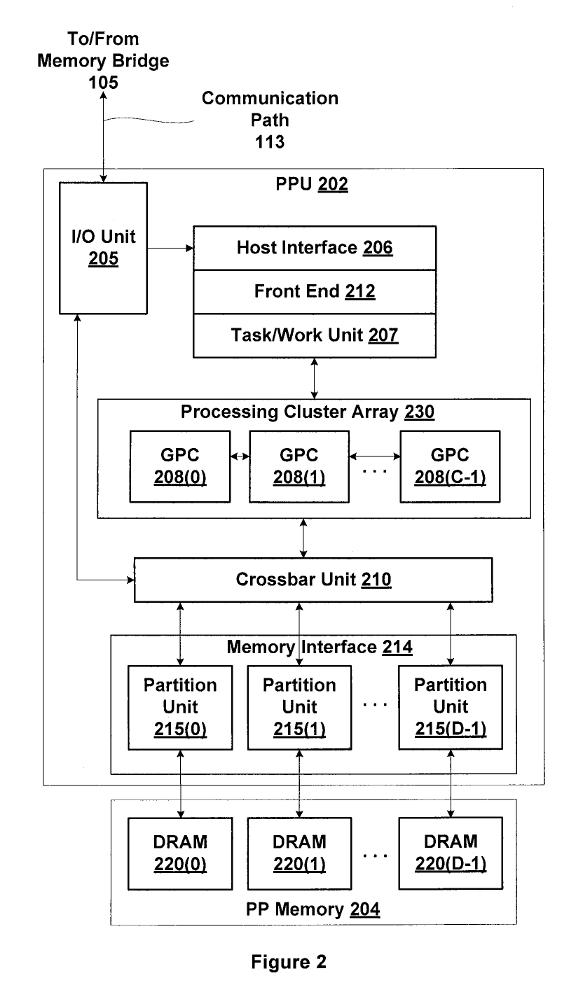

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or image frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Wireless Display Synchronization for Mobile Devices

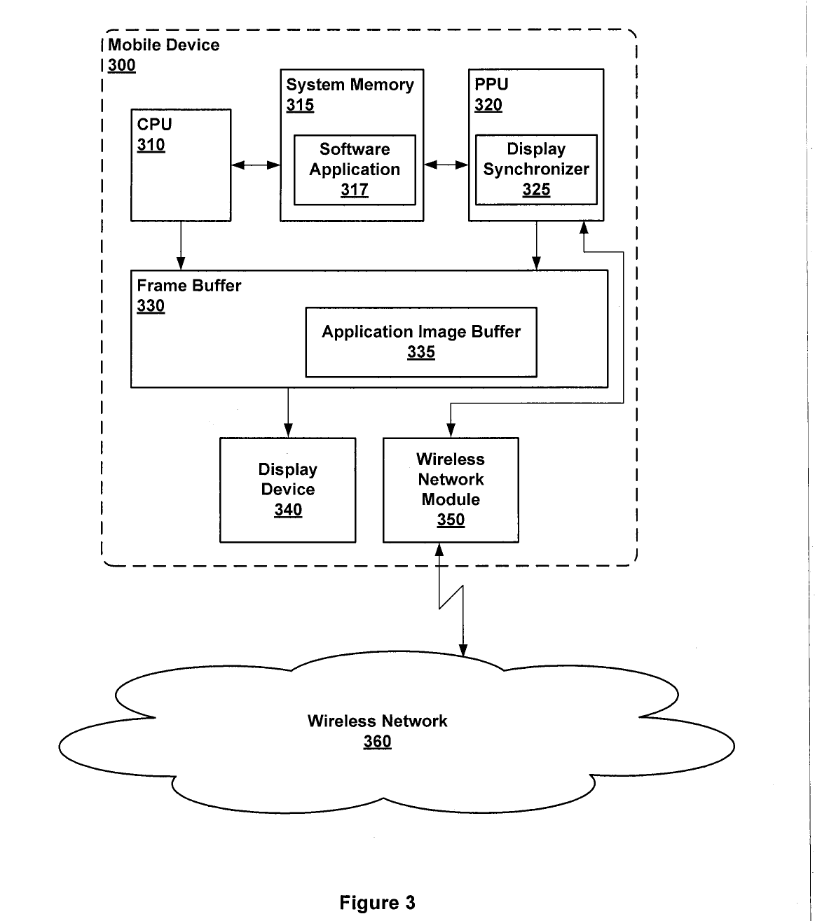

FIG. 3 is a block diagram of a mobile device 300, according to one embodiment of the present invention. As shown, the mobile device 300 at least partially embodies the computer system 100 of FIG. 1 and includes a CPU 310, a system memory 315, a PPU 320, a frame buffer 330, a display device 340, and a wireless network module 350 that is communicatively connected to a wireless network 360. The CPU 310, system memory 315, PPU 320, and display device 340 function substantially as described in conjunction with FIGS. 1-2 except as further described below.

The CPU 310 accesses instructions and data located in the system memory 315. In particular, the CPU 310 executes a software application 317 that resides in system memory 315, as further described herein. The CPU 310 also accesses the frame buffer 330 to read and write image data stored in the frame buffer 330.

The system memory 315 includes the software application 317 executed by the CPU 310, where the software application 317 is configured to be synchronized the like software applications executing on other mobile devices. For example, the software application 317 could be a video player application that plays a video clip or a computer-aided-design (CAD) application that accesses and displays a set of user-created drawings. The system memory 315 may also include a region (not shown) for receiving and storing render commands from the CPU 310, where the render commands are directed to the PPU 320.

The PPU 320 receives render commands from the CPU 310, where the render commands direct the PPU 320 to render image frames into the frame buffer 330. The PPU 320 may receive these render commands by retrieving the commands from a region in the system memory 315, where the commands were previously stored in the region by the CPU 310. Alternatively, the PPU 320 may receive the render commands directly from the CPU 310 via a communications link (not shown) between the CPU 310 and the PPU 320. The PPU 320 renders image frames associated the software application 317 into a buffer space within a corresponding application image buffer 335 in the frame buffer 330. The PPU 320 also communicates with the wireless network module 350 to communicate with other mobile devices.

The frame buffer 330 is a memory system that includes image data for display on the display device 340. The PPU 320 may merge image data from various application buffers, such as application image buffer 335, with other image data, such as background images and icon data, and store the merged image data in a region of the frame buffer 330. The merged image data is then transmitted from the frame buffer 330 to the display device 340 for display.

The display device 340 receives merged image data from the frame buffer 330 for display. The image data received from the frame buffer 330 may be double-buffered, where image data for a current frame is retrieved from a first buffer (the front buffer) for display on the display device 340. Simultaneously, image data for the next image frame is written to a second buffer (the back buffer) in the frame buffer 330. Once all of the image data for the next image frame is written into the back buffer, the front buffer and the back buffer are swapped, such that the new front buffer, including the image data for the next image frame, is now transmitted to the display device. The new back buffer then collects image data for a subsequent image frame.

The application image buffer 335 includes image data corresponding to the software application 117. The application image buffer 335 may be double-buffered in the manner described for the frame buffer 330. Accordingly, the PPU 320 may render an image frame associated with the software application 317 into a back buffer of the application image buffer 335 while a front buffer of the application image buffer 335 is displayed on the display device 335.

As also shown, the PPU 320 includes a display synchronizer 325 configured to synchronize display of the image data in the application image buffer 335 with image data of other mobile devices. The behavior of the display synchronizer 325 depends on whether the mobile device 300 is configured as a master mobile device for the software application 317, or as a non-master mobile device.

If the mobile device 300 is configured as a master mobile device, then the mobile device 300 creates a share group associated with the software application 317. The mobile device 300 accepts and grants join requests from other mobile devices to join the share group. Each mobile device in the share group executes software application 317 with the same input visual content. The PPU 320 renders an image frame associated with the software application 317 into the back buffer of the application image buffer 335. The display synchronizer 325 then waits to receive an acknowledgment signal from each of the other mobile devices in the share group, where the acknowledgment signal indicates that the respective mobile device has completed rendering of the image data into that mobile device's back buffer. In some embodiments, the display synchronizer 325 may lock the back buffer to prevent additional rendering into the back buffer until the acknowledgment signal is received from all other mobile devices in the share group. The display synchronizer 325 transmits a swap signal to the share group, causing the other mobile devices in the share group to swap respective front and back buffers. The mobile device 300 likewise swaps the front and back buffer of the application image buffer 335. In some embodiments, the display synchronizer 325 may unlock the back buffer to allow rendering of the next image frame into the back buffer. As a result, all mobile devices in the share group display the same image data. The process continues until the software application 317 completes execution or otherwise indicates that application synchronization is terminated. The display synchronizer 325 then deletes the share group.

If the mobile device 300 is configured as a non-master mobile device, then the mobile device 300 requests to join the share group associated with the software application 317. Upon receiving a grant to join the group from the master mobile device, the PPU 320 renders an image frame associated with the software application 317 into the back buffer of the application image buffer 335. The display synchronizer 325 then waits for the master mobile device to issue a swap signal. In some embodiments, the display synchronizer 325 may lock the back buffer to prevent additional rendering into the back buffer until the swap signal is received from the master mobile device. When the display synchronizer 325 receives the swap signal, the display synchronizer 325 swaps the front buffer and the back buffer of the application image buffer 335. In some embodiments, the display synchronizer 325 may unlock the back buffer to allow rendering of the next image frame into the back buffer. The display synchronizer 325 transmits an acknowledgement to the master mobile device of the share group. The PPU 320 then renders image data associated with the software application 317 into the new back buffer. The process continues until the mobile device leaves the share group or until the master mobile device deletes the share group.

The wireless network module 350 receives and transmits synchronization signals between the mobile device 300 and other mobile devices in the share group. If the mobile device 300 is configured as a master mobile device, then the wireless network module 350 receives join requests and swap acknowledgements from non-master mobile devices and transmits these signals to the display synchronizer 325. The wireless network module 350 receives join grants and swap signals from the display synchronizer 325 and transmits these signals to the non-master mobile devices. If the mobile device 300 is configured as a non-master mobile device, then the wireless network module 350 receives join requests and swap acknowledgements from the display synchronizer 325 and transmits these signals to the master mobile device. The wireless network module 350 receives join grants and swap signals from the master mobile device and transmits these signals to the display synchronizer 325. The wireless network module 350 communicates to other mobile devices in the share group over the wireless network 360.

The wireless network 360 receives and transmits signals, data, and other messages between the mobile device 300 and other mobile devices in the share group. The wireless network 360 may support any technically feasible network protocol including, without limitation, Wi-Fi, Bluetooth, and a cellular network.

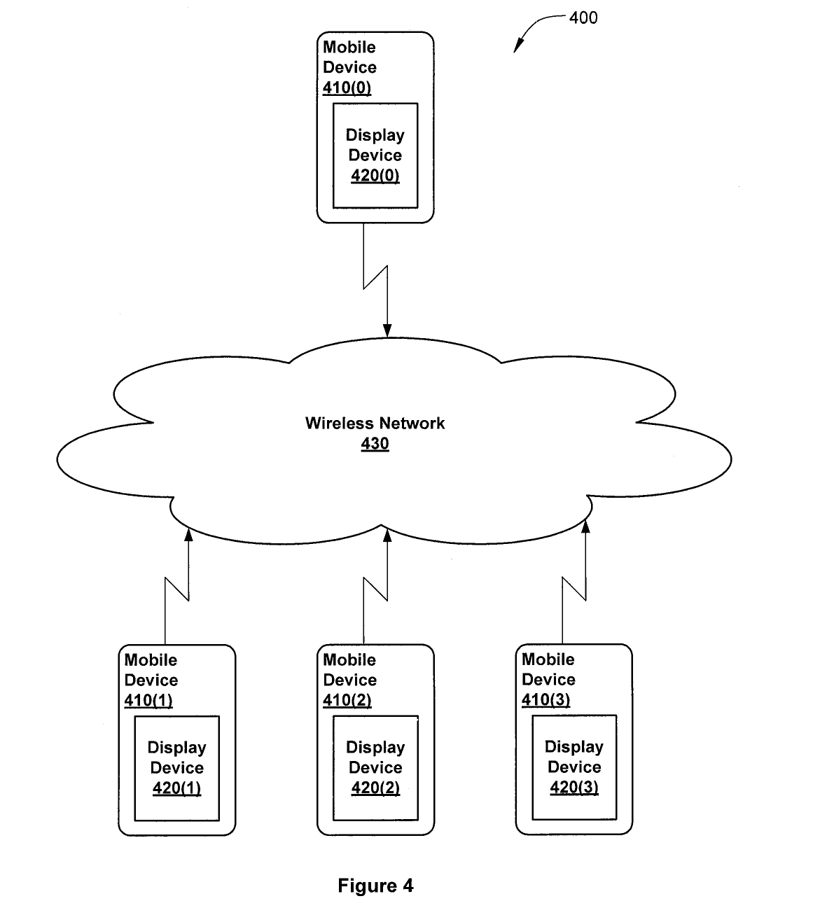

FIG. 4 illustrates a share group 400 of mobile devices 410 communicating over a wireless network, according to one embodiment of the present invention. As shown, the share group 400 includes mobile devices 410 and a wireless network 430. The mobile devices 410 and the wireless network 430 function substantially as described in conjunction with FIGS. 1-3 except as further described below.

The mobile devices 410 form a share group 400 to synchronize image data associated with a software application executing on the mobile devices 410. One of the mobile device 410(0) creates a share group 400 associated with the software application. As such, the mobile device 410(0) becomes the master mobile device of the share group 400. Each of the other mobile devices 410(1) 410(2) 410(3) transmit a join request to the mobile device 410(0) over the wireless network 430. The mobile device 410(0) transmits join grants to the other mobile devices 410(1) 410(2) 410(3) over the wireless network 430. The other mobile devices 410(1) 410(2) 410(3) become non-master mobile devices of the share group 400.

The mobile devices 410 then render image data associated with the software application into a back buffer of an associated application buffer. As each non-master mobile device 410(1) 410(2) 410(3) completes rendering of the image data, the respective non-master mobile device 410(1) 410(2) 410(3) transmits an acknowledgment signal to the master mobile device 410(0) over the wireless network 430. In some embodiments, the master mobile device 410(0) may lock the back buffer of the local application buffer to prevent additional rendering into the back buffer until the acknowledgment signal is received from all other mobile devices in the share group. When an acknowledgement is received from all non-master mobile devices, the master mobile device 410(0) then swaps the front and back buffer of the local application buffer and transmits a swap signal to the non-master mobile device 410(1) 410(2) 410(3) over the wireless network 430. In response, the non-master mobile device 410(1) 410(2) 410(3) swaps the front and back buffer of the respective application buffers. In some embodiments, the non-master mobile device 410(1) 410(2) 410(3) may lock the back buffer to prevent additional rendering into the back buffer until the swap signal is received from the master mobile device 410(0).

Correspondingly, all mobile devices 410(0) 410(1) 410(2) 410(3) in the share group 400 display the same image data on the respective display devices 420(0) 420(1) 420(2) 420(3). All mobile devices 410(0) 410(1) 410(2) 410(3) in the share group 400 then start rendering a next image frame into respective new back buffers. In some embodiments, the display synchronizer 325 may unlock the back buffer to allow rendering of the next image frame into the back buffer. Likewise, in some embodiments, the display synchronizer 325 may unlock the back buffer to allow rendering of the next image frame into the back buffer. The process continues until the master mobile device 410(0) deletes the share group 400. Each non-master mobile device 410(1) 410(2) 410(3) may individually leave the share group 400.

It will be appreciated that the system shown herein is illustrative and that variations and modifications are possible. For example, the techniques described herein are in the context of a CPU executing a software application and a PPU that includes a display synchronizer. However, any technically feasible processing unit could be configured to execute the software application and the display synchronizer, including, without limitation, a central processing unit, a parallel processing unit, or other auxiliary processing unit.

In another example, the frame buffer and application buffer described herein are double-buffered, including a front buffer and a back buffer. However, the frame buffer and application buffer could include any technically feasible quantity of buffers, such as three buffers or four buffers. Such additional buffers could provide additional latency buffering where one of the buffers is displayed on the display device while image data is rendered into any one or more of the other buffers. As such, the frame buffer and application buffer would include one front buffer and multiple back buffers. Alternatively, the additional buffers could support stereo or multiview image data. Image data from two front buffers could be displayed on the display device, where one front buffer would include left-eye image data and the other front buffer would include right-eye image data. Likewise, image data could be rendered into two back buffers, where one back buffer would include left-eye image data and the other back buffer would include right-eye image data.

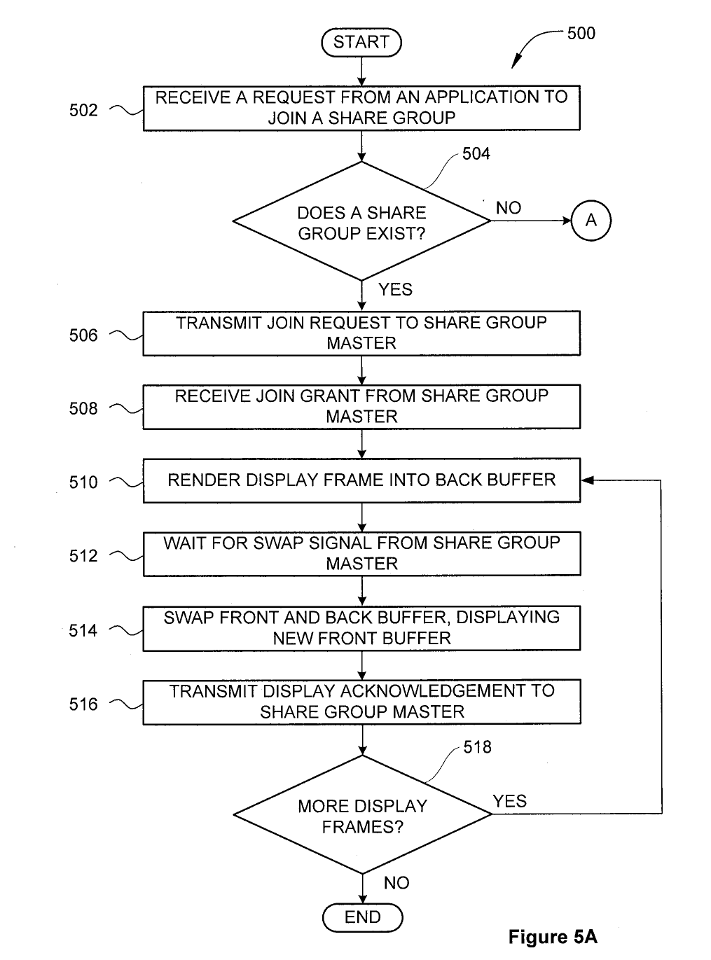

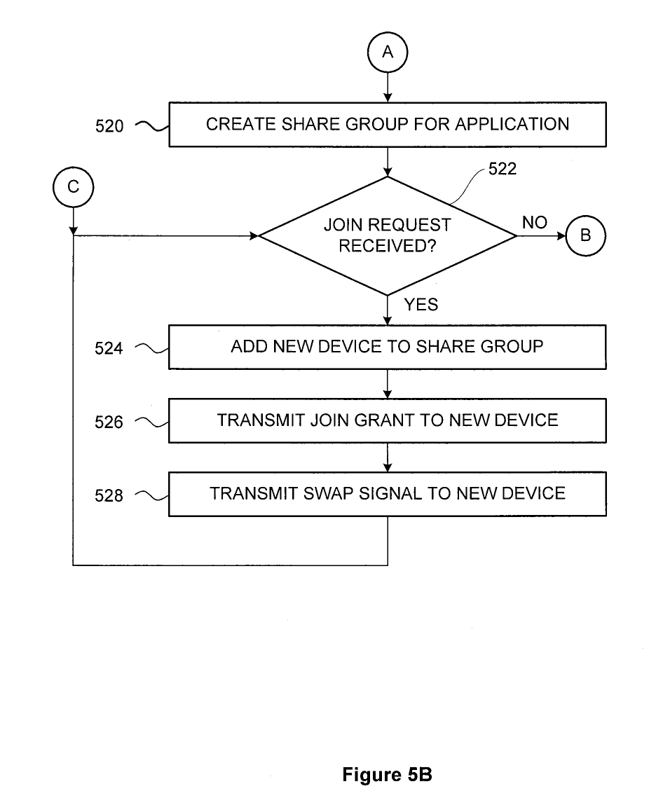

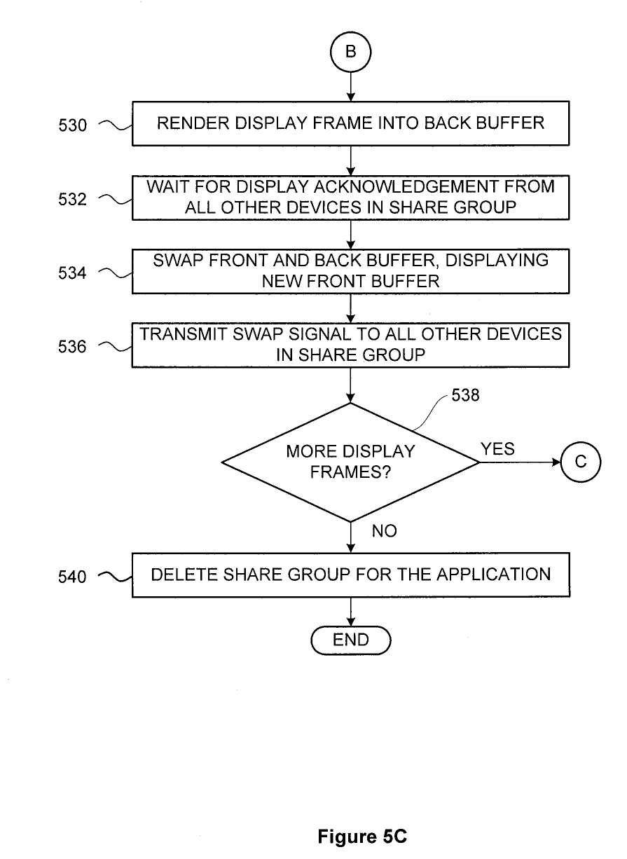

FIGS. 5A-5C set forth a flow diagram of method steps for synchronizing display buffers of a plurality of mobile devices, according to one embodiment of the present invention. Although the method steps are described in conjunction with the systems of FIGS. 1-4, persons of ordinary skill in the art will understand that any system configured to perform the method steps, in any order, is within the scope of the invention.

As shown, a method 500 begins at step 502, where the display synchronizer 325 receives a request from an application to join a share group. At step 504, the display synchronizer 325 determines whether a share group exists for the application. If a share group exists for the application, then the method 500 proceeds to step 506, where the display synchronizer 325 transmits a join request to the share group master mobile device. At step 508, the display synchronizer 325 receives a join grant from the share group master mobile device. At step 510, the display synchronizer 325 renders an image frame into the back buffer. The particular image frame to render may be specified by the share group master mobile device. At step 512, the display synchronizer 325 waits for a swap signal to be received from the share group master mobile device. In some embodiments, the display synchronizer 325 may lock the back buffer to prevent additional rendering into the back buffer until the swap signal is received from the master mobile device. At step 514, after the swap signal is received, the display synchronizer 325 swaps the front buffer and the back buffer, displaying the new front buffer. The new front buffer is the previous back buffer into which the image frame was rendered. In some embodiments, the display synchronizer 325 may unlock the back buffer to allow rendering of the next image frame into the back buffer. At step 516, the display synchronizer 325 transmits a display acknowledgement to the share group master mobile device upon completing rendering the image frame. At step 518, the display synchronizer 325 determines whether there are additional image frames to process. If there are additional image frames to process, then the method proceeds to step 510, described above. If, at step 518, there are no additional image frames to process, then the method 500 terminates.

Returning now to step 504, if a share group does not exist for the application, then the method 500 proceeds to step 520, where the display synchronizer 325 creates a share group for the requesting application. At step 522, the display synchronizer 325 determines whether a join request has been received from another mobile device. If a join request has been received from another mobile device step 524, then the method proceeds to step 524, where the display synchronizer 325 adds the new device to the share group of the application. At step 526, the display synchronizer 325 transmits a join grant to the new device. At step 528, the display synchronizer 325 transmits a swap signal to the new device, so that the new device can render a first frame into the back buffer of the new device. The method 500 then proceeds to step 522, described above.

Returning now to step 522, if a join request is not received, then the method 500 proceeds to step 530, where the display synchronizer 325 renders a image frame into the back buffer. At step 532, the display synchronizer 325 waits for a display acknowledgement to be received from all other mobile devices in the share group. In some embodiments, the display synchronizer 325 may lock the back buffer to prevent additional rendering into the back buffer until the acknowledgment signal is received from all other mobile devices in the share group. At step 534, the display synchronizer 325 swaps the front buffer and the back buffer, displaying the new front buffer. The new front buffer is the previous back buffer into which the image frame was rendered. In some embodiments, the display synchronizer 325 may unlock the back buffer to allow rendering of the next image frame into the back buffer. At step 536, the display synchronizer 325 transmits a swap signal to all other devices in the share group. At step 538, the display synchronizer 325 determines whether there are additional image frames to process. If there are additional image frames to process, then the method proceeds to step 522, described above. If, at step 538, there are no additional image frames to process, then the method 500 proceeds to step 540, where the display synchronizer 325 deletes the share group for the application. The method 500 then terminates.

In sum, a master mobile device creates a share group associated with a particular software application. Other mobile devices transmit requests to the master mobile device to join the share group. The master mobile device grants the join requests. Each mobile device in the share group, including the master mobile device, starts to render an image frame into a back buffer of the respective mobile device while displaying a front buffer on the display of the mobile device. Each non-master mobile device in the share group then transmits a display acknowledgement to the master mobile device after the rendering of the image frame into the back buffer completes. When the master mobile device receives a display acknowledgement from each non-master mobile device, the master mobile device transmits a swap signal to the share group. Each mobile device then swaps the front and back buffers, causing the old back buffer to be displayed as the new front buffer. Each mobile device then starts rendering the next image frame into the new back buffer. The process repeats until the share group is deleted by the master mobile device or all mobile devices leave the share group.

One advantage of the disclosed approach is that a group of mobile devices stay frame-synchronized during playback of visual content or during execution of a software application. A presenter may ensure that all non-master mobile devices are synchronized to the master mobile device during a presentation or training program.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A method for synchronizing displays of a plurality of mobile devices over a wireless network, the method comprising:
rendering a first image frame related to a software application into a first application image buffer associated with a first mobile device;
causing a second mobile device to render a second image frame substantially similar to the first image frame into a second application image buffer associated with the second mobile device;
receiving an acknowledgement over a wireless network indicating that the second mobile device has completed rendering the second image frame into the second application image buffer;
displaying contents of the first application image buffer on a first display device associated with the first mobile device; and
transmitting a signal to the second mobile device over a wireless network that causes the second mobile device to display contents of the second application image buffer on a second display device associated with the second mobile device.

2. The method of claim 1, further comprising:
rendering a third image frame into a third application image buffer associated with the first mobile device; and
causing the second mobile device to render a fourth image frame substantially similar to the second image frame into a fourth application image buffer associated with the second mobile device.

3. The method of claim 1, further comprising:
determining that the software application is not associated with a share group; and
in response, creating a first share group associated with the software application.

4. The method of claim 3, further comprising receiving a request from the second mobile device to join the first share group.

5. The method of claim 4, further comprising:
in response to receiving the request, adding the second mobile device to the first share group; and
transmitting a join grant message to the second mobile device.

6. The method of claim 5, further comprising:
receiving a request from the third mobile device to join the first share group;
adding the third mobile device to the first share group; and
transmitting a join grant message to the third mobile device.

7. The method of claim 6, further comprising:
determining that the second mobile device has left the first share group; and
in response, deleting the second mobile device from the first share group.

8. The method of claim 3, further comprising:
determining that the software application has terminated execution; and
terminating the first share group.

9. The method of claim 3, further comprising:
receiving a request from the software application to delete the first share group; and
terminating the first share group.

10. A system comprising:
a first processing unit configured to execute a software application; and
a second processing unit comprising:
a display synchronizer configured to:
render a first image frame related to a software application into a first application image buffer associated with a first mobile device;
cause a second mobile device to render a second image frame substantially similar to the first image frame into a second application image buffer associated with the second mobile device;
receive an acknowledgement over a wireless network indicating that the second mobile device has completed rendering the second image frame into the second application image buffer;
display contents of the first application image buffer on a first display device associated with the first mobile device; and
transmit a signal to the second mobile device over a wireless network that causes the second mobile device to display contents of the second application image buffer on a second display device associated with the second mobile device.

11. The system of claim 10, wherein the display synchronizer is further configured to:
render a third image frame into a third application image buffer associated with the first mobile device; and
cause the second mobile device to render a fourth image frame substantially similar to the second image frame into a fourth application image buffer associated with the second mobile device.

12. The system of claim 10, wherein the display synchronizer is further configured to:
determine that the software application is not associated with a share group; and
in response, create a first share group associated with the software application.

13. The system of claim 12, wherein the display synchronizer is further configured to receive a request from the second mobile device to join the first share group.

14. The system of claim 13, wherein the display synchronizer is further configured to:
in response to receiving the request, add the second mobile device to the first share group; and
transmit a join grant message to the second mobile device.

15. The system of claim 14, wherein the display synchronizer is further configured to:
receive a request from the third mobile device to join the first share group;
add the third mobile device to the first share group; and
transmit a join grant message to the third mobile device.

16. The system of claim 15, wherein the display synchronizer is further configured to:
determine that the second mobile device has left the first share group; and
in response, delete the second mobile device from the first share group.

17. The system of claim 12, wherein the display synchronizer is further configured to:
determine that the software application has terminated execution; and
terminate the first share group.

18. The system of claim 12, wherein the display synchronizer is further configured to:
receive a request from the software application to delete the first share group; and
terminate the first share group.

19. The system of claim 10, wherein the display synchronizer is further configured to:
cause a third mobile device to render a third image frame substantially similar to the first image frame into a third application image buffer associated with the third mobile device;
receive an acknowledgement over a wireless network indicating that the third mobile device has completed rendering the third image frame into the third application image buffer; and
transmit a signal to the third mobile device over a wireless network that causes the third mobile device to display contents of the third application image buffer on a third display device associated with the third mobile device.

20. A computing device for synchronizing displays of a plurality of mobile devices over a wireless network, comprising:
a processing unit; and
a memory containing instructions, that, when executed by the processing unit, cause the processing unit to:
render a first image frame related to a software application into a first application image buffer associated with a first mobile device;
cause a second mobile device to render a second image frame substantially similar to the first image frame into a second application image buffer associated with the second mobile device;
receive an acknowledgement over a wireless network indicating that the second mobile device has completed rendering the second image frame into the second application image buffer;
display contents of the first application image buffer on a first display device associated with the first mobile device; and
transmit a signal to the second mobile device over a wireless network that causes the second mobile device to display contents of the second application image buffer on a second display device associated with the second mobile device.
